(19) United States
(12) Patent Application Publication
(10) Pub. No.: US 2012/0085935 A1
(43) Pub. Date: Apr. 12, 2012

(54) Apparatus for Seeing Fluorescent Indicia in Dark Conditions

(76) Inventor: Richard NASEF, Santa Fe, NM (US)

(21) Appl. No.: 13/253,803

(22) Filed: Oct. 5, 2011

Related U.S. Application Data
(60) Provisional application No. 61/404,761, filed on Oct. 8, 2010.

(51) Int. Cl. G21K 5/00; F21L 14/02

(52) U.S. Cl. 250/492.1; 250/504 H

(57) ABSTRACT

A portable source of irradiation which emits only UV light with no visible light component for illuminating and exciting objects containing materials excited by UV light including an opaque housing, a source of substantially only UV light with no visible light component provided in the housing, and a power source for the source of the substantially only UV light provided in the housing. Preferably the source of substantially only UV light includes an UV LED and a high pass filter lens provided on an optical axis with and in front of the source.

### INCORPORATION BY REFERENCE

The contents of Provisional Application No. 61/404,761 filed on Oct. 8, 2010 are hereby incorporated by reference.

### BACKGROUND OF THE INVENTION

1. Field of Invention

The present invention relates to an apparatus for seeing fluorescent indicia in dark conditions in a stealth fashion.

2. Prior Art

In the dark it is essential to sometimes see things such as object, other people, labels, etc. The common way to accomplish this task is to use a visible light source. However, utilization of a visible light source immediately identifies the location of the user to everyone who is located in the surrounding dark area and damages the user's night vision. In certain conditions this may be a disadvantage and may present the user of the visible light source as a target.

### SUMMARY OF THE INVENTION

Accordingly it is an object of the present invention to overcome the disadvantages of the prior art.

In particular it is an object of the present invention to stealthily illuminate objects under dark conditions.

In keeping with the principles and objects of the present invention, the present invention is a new portable source of irradiation which emits only UV light with no visible light component for illuminating and exciting objects containing materials excited by UV light under dark conditions including an opaque housing, a source of substantially only UV light with no visible light component provided in the housing, and a power source for the source of substantially only UV light provided in the housing.

### DESCRIPTION OF THE FIGURES

The above mention features and objects of the present invention will be discussed herein below with reference to the following figures in which like reference characters refer to like elements and in which:

FIG. 1 illustrates the circuit diagram for turning on and off the LED in the present invention;

FIG. 2 illustrates the appearance of the present invention;

FIGS. 3 and 4 illustrates a light source utilized in the present invention with FIG. 4 taken along the line 4-4 in FIG. 3; and

FIG. 5 illustrates the utilization of the present invention.

### DESCRIPTION OF THE INVENTION

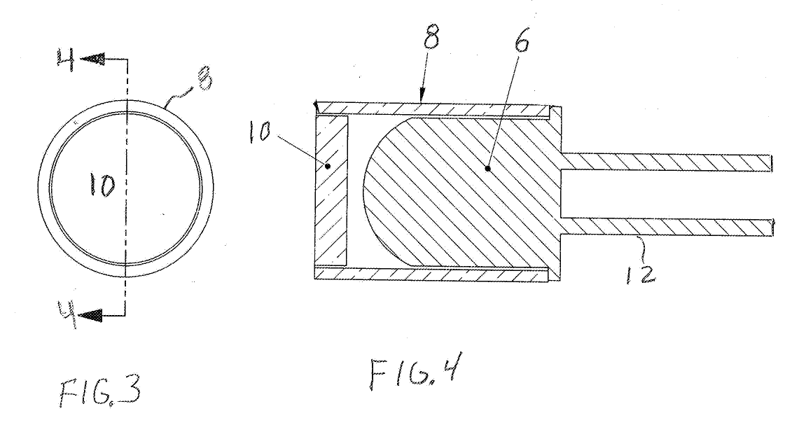

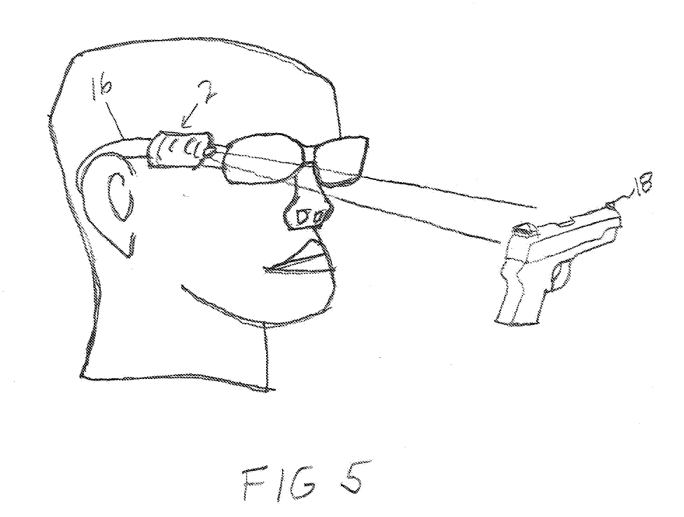

In the present invention it is essential to utilize a source of irradiation 2 which is capable of exciting fluorescent materials. However, it is also essential that the source of irradiation 2 emit no visible light so that the source of irradiation 2 provides only a source of ultraviolet light. Referring to the FIGS. 1 to 4 shown therein is shown such a source of irradiation 2. The source 2 comprises an LED 6 which substantially only emits ultraviolet light and is of an appropriate size, all of which are illustrated in the FIGS. 1, 3 and 4. The LED 6 is provided inside of an opaque tube 8 which can be made from any suitable opaque material such as a resin or a metal and which is illustrated in the FIGS. 1, 3 and 4. While the LED 6 emits substantially only ultraviolet light, it is essential that the source 2 emit no visible light. As a result, a filter 10 is provided in one end of the tube 8 so that the light which comes from the UV source is substantially only ultraviolet light and therefore has a filtering characteristic comprising a high pass filter which only passes irradiation which is not visible light, namely approximately a wavelength which is equal to or less than the wavelength of ultraviolet light (approximately 470 nanometers); such a filter 10 in the present invention is illustrated in the FIGS. 1, 3 and 4.

Referring to FIG. 1, the UV source comprising the LED 6, tube 8 and filter 10 is provided in a housing 10. The LED 6 is connected to a battery B1 and a switch SW1 by means of leads 12. Accordingly the UV source can be turned on and off by means of the switch SW1.

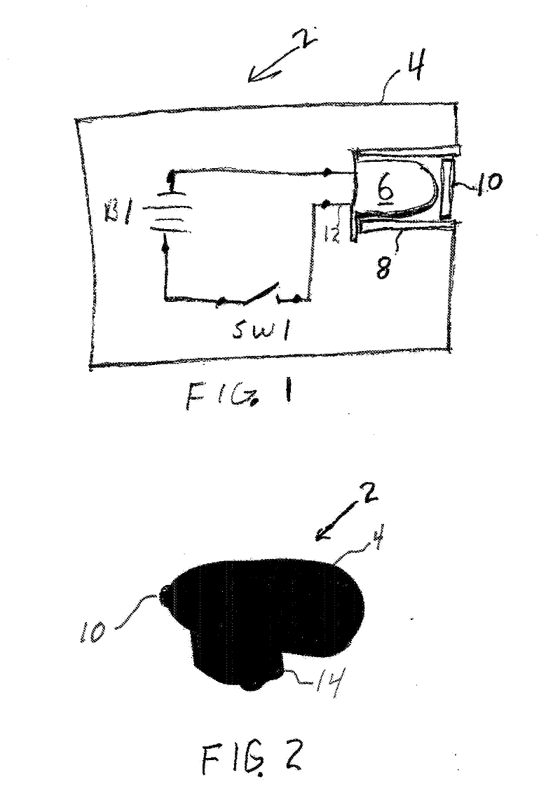

The housing 10 should be of a suitable size to house all of the components and also be light in weight and as small in size as possible as shown in FIG. 2. In addition the housing 10 should be provided with an attachment means 14 for attaching the housing 10 to a pair of eyeglasses 16, a pocket, a shirt, a metallic plate, etc. Such means includes such things as a clip, pin, magnet, etc. Shown in FIG. 5 is the present invention attached to a pair of eyeglasses 16 with the beam of only ultraviolet light illustrated. In practice, such a beam would be invisible to the human eye and is only included in this figure for the purposes of illustration.

In use, the present invention could be turned on and utilized in conjunction with a plurality of different uses employing UV light excitable materials such as fluorescent materials. Such things would include the sight of a firearm such as a pistol, rifle or shotgun as shown in FIG. 5. Accordingly, with the present invention the sights 18 could be easily seen by the wearer of the present invention without illuminating or identifying the user in the dark conditions. Therefore, the use of a flashlight to be able to see the sights 18 on one's firearm would be eliminated since the fluorescent material of the sights 18 would be excited by the UV light from the source 2.

In other uses it may be necessary for a medic in combat conditions to be able to read the labels on medications, tools, bandages, etc. without being seen. As a result, labels on such things used by a medic could be printed in fluorescent materials and illuminated by the present invention so that the medic could stay in a stealth condition and not be illuminated by a flashlight while treating an injured individual.

Also in some situations it may be advantageous to be able to easily recognize the members of your own team. In such situations all of the members of the team would be provided with the present invention and fluorescent indicia could be provided on the clothing or headgear.

In addition, the present invention could be used by ushers at theaters, concerts, etc. to illuminate the row and seat. Indicia could be printed on the seat and rows in fluorescent material and excited by the source 2 without disturbing the other patrons.

It should be apparent to those skilled in the art that the above described embodiment represents but one embodiment of the present invention. Numerous and other varied embodiments could be created without departing from the spirit and scope of the invention.

1: A portable source of irradiation which emits only UV light with no visible light component for illuminating and exciting objects containing materials excited by UV light, said source of irradiation comprising:
an opaque housing;
a source of substantially only UV light with no visible light component provided in said housing, and
a power source for the source of substantially only UV light provided in the housing.

2: The source of irradiation according to claim 1, wherein said source of substantially only UV light with no visible light component comprises an UV LED and a high pass filter lens provided in front of said LTV LED, said UV filter lens having a cut-off wavelength of 470 nanometers.

3: The source of irradiation according to claim 2 wherein said UV LED is a UV Laser.

4: The source of irradiation according to claim 4 wherein the source of substantially only UV light further comprises an opaque tube with said UV LED inserted into one end and said UV filter lens provided in another end.

5: The source according to claim 4 wherein said object comprises the sights containing material excited by UV light of a firearm.

6: The source of irradiation according to claim 5 wherein said material excited by UV light is fluorescent material.

7: The source of irradiation according to claim 6 further comprising an attachment means for attaching said source to one selected from the group consisting of a pair of eyeglasses, a pocket, a shirt, a metallic plate.

8: A method of illuminating stealthily the sights of a firearm without visible light comprising the steps of:
providing an UV excitable material in the sights of the firearm; and
illuminating the sights with a source of substantially only UV light with no visible light component from a portable source of irradiation which emits only UV light with no visible light component for illuminating and exciting objects containing materials excited by UV light and which comprises an opaque housing, a source of substantially only UV light with no visible light component provided in said housing, and a power source for the source of substantially only LTV light provided in the housing.
